(19) United States
(12) Patent Application Publication
(10) Pub. No.: US 2005/0197905 A1
(43) Pub. Date: Sep. 8, 2005

(54) Method of presenting new technology at a trade show

(76) Inventors: Neal Koller, Annapolis, MD (US); Nahid Kiani, Montgomery Village, MD (US); Lance Hoboy, Silver Spring, MD (US); George Robertson, Strasburg, PA (US)

Correspondence Address: EVANS & MOLINELLI, PLLC, 6411 CHAPEL VIEW ROAD, CLIFTON, VA, 20124, US

(21) Appl. No.: 11/072,190

(22) Filed: Mar. 4, 2005

Related U.S. Application Data
(60) Provisional application No. 60/550,470, filed on Mar. 5, 2004.

(51) Int. Cl. G06F 17/60

(52) U.S. Cl. 705/14

(57) ABSTRACT

Techniques for presenting new technology at a trade show include sending, to candidate exhibitors for a trade show in an industry, applications to present an exhibit at the trade show as a new technology directed to the industry. Completed applications are received from at least one exhibitor. Experts are determined within the industry who are substantively independent of the exhibitor from whom the completed application is received. Expert reviews are obtained from the experts based on at least a subset of the one or more completed applications. Based on the expert reviews, a particular exhibit is presented at the trade show as a new technology.

### CROSS-REFERENCE TO RELATED APPLICATIONS

This application claims benefit of Provisional Appln. 60/550,470, filed Mar. 5, 2004, the entire contents of which are hereby incorporated by reference as if fully set forth herein, under 35 U.S.C. §119(e).

### BACKGROUND OF THE INVENTION

1. Field of the Invention

The present invention relates to a method for presenting new technologies in an industry trade show; and, in particular, to presenting at an industry trade show products and services that represent actual advances in technology for the industry.

2. Description of the Related Art

Trade shows represent important opportunities for producers in a particular industry to present products and services that are available and for consumers in that industry to learn of those products and services, to discuss preferences and to indicate their needs. Society benefits when the right products or services or both are more quickly applied to the most glaring needs. Trade shows accelerate this process of matching existing and advanced technologies to outstanding needs.

Exhibits of great interest at many trade shows display new advances in products and services being applied to an industry. Unfortunately, many of the exhibits are new in minor ways, such as in name or packaging, rather than in terms of any significant technological innovations.

Based on the foregoing, there is a clear need for techniques for highlighting products and services in a trade show that represent significant advances in the technologies applied to the industry.

### SUMMARY OF THE INVENTION

Techniques are provided for presenting new technology at a trade show. These techniques allow trade show organizers to distinguish exhibits that represent real technological advances from exhibits that are new in fairly minor ways.

In one set of embodiments of the invention, a method includes sending, to candidate exhibitors for a trade show in an industry, applications to present an exhibit at the trade show as a new technology directed to the industry. Completed applications are received from at least one exhibitor. Experts are determined within the industry who are substantively independent of the exhibitors from whom the completed applications are received. Expert reviews are obtained from the experts based on at least a subset of the completed applications. Based on the expert reviews, a particular exhibit is presented at the trade show as a new technology.

In another set of embodiments of the invention, a computer readable medium includes instructions that cause a processor to perform steps for presenting new technology at a trade show.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates a method for presenting new technology at a trade show, according to an embodiment;

FIG. 2 is a flow diagram that illustrates in more detail a step in the method of FIG. 1, according to another embodiment; and

FIG. 3 is a block diagram that illustrates a computer system upon which at least part of an embodiment of the invention may be implemented.

### DETAILED DESCRIPTION

Techniques are described for presenting new technology at a trade show. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Functional Overview

Trade associations and other organizations often administer trade shows for encouraging commerce, best practices and technological advancement in an industry. For example, a pharmacological trade association is dedicated to help its members find the best methods to develop and test and introduce new chemicals for human treatment and consumption and to submit them to government regulations. As technologies for manufacture and testing that support these activities improve, the association evaluates or presents these technologies to its membership, or both. The presentation may be made within an organization's literature and periodicals. Often the presentations are made by vendors of certain services and products at trade shows administered by the organization and supported by funds from the vendors or attendees or both.

Of special interest to attendees are technological advances offered by the vendors. Embodiments of the invention assist the organizations in identifying and presenting the products and services that represent the most significant technological advances so that they can be distinguished from the other products and services offered at a trade show administered by the organization. The ability to identify the most significant technological advances is a unique service provided by the organization that is often not available from the vendors themselves or government bodies. In embodiments of the invention, new technologies are not assessed based solely on claims by the vendors but undergo one or more rounds of peer review by those knowledgeable about the industry.

For clarity and simplicity, embodiments of the invention are described in the context of a technology trade show administered by an independent industry organization, but the invention is not limited to this context, and can be employed by government bodies, professional associations, and other organizations for conferences of all types that include varied presentations of technology-based products and services. As used herein, an “exhibit” is a description of a product or service offered by a vendor or agency of any type at a gathering of any type. A “trade show” is convocation of any type that includes varied presentations of technology-based products and services by multiple vendors.

In an illustrated embodiment for a pharmaceutical industry organization, criteria to be considered during the peer review process include, but are not limited to, any or all of the following:

A. Incremental Benefit to Current Practice

1. Cost
2. Speed
3. Accuracy
   B. Incremental Benefit for Application in Human Life Sciences
1. Pharmaceutical
2. Biopharmaceutical
3. Medial Device
4. Other Human Life Sciences
   C. Incremental Benefit for
1. Product Manufacturing
2. Product Testing
3. Product Research & Development
4. Product Quality
5. Product Regulation
   D. Time of First Commercial Sale
1. Actual date in last 12 months before exhibit date
2. Projected sale in next 12 months after exhibit date
   E. Full Financing to Complete Commercialization
   F. Current Stage of Development (e.g., Simulated, Prototype, Test Data, Performance Data, Production Model, Fill Factory Production)
   G. Strategic Plan
   H. Membership Voting and Weights
1. Experts
2. Emeritus
3. Individual
   a. Academic
   b. Government
   c. Retiree
   d. Electronic
   e. Other
4. Associate
   a. Student
   b. Other
5. Honorary

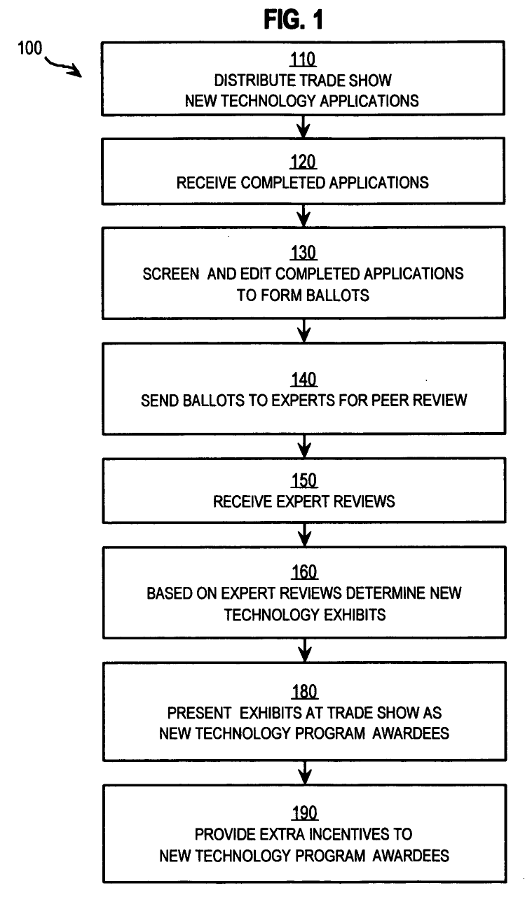

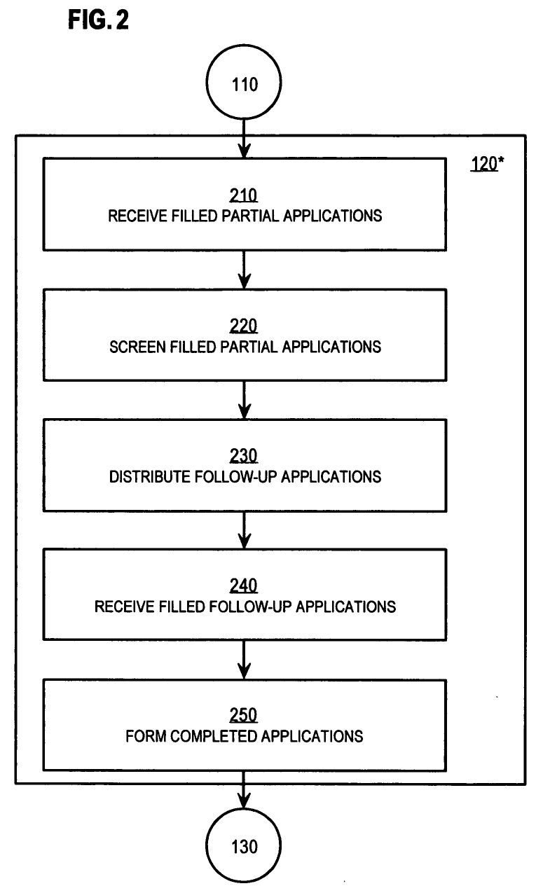

FIG. 1 is a flow diagram that illustrates a method 100 for presenting new technology at a trade show, according to an embodiment. Although steps are shown in FIG. 1 and FIG. 2 in a particular order for purposes of illustration, in other embodiments the steps may be performed in a different order or overlapping in time. In some embodiments, one or more steps may be omitted.

In some embodiments, at least some of the steps depicted in FIG. 1 are performed automatically by a processor under software control, as described in the Hardware overview section.

In step 110, the organization distributes applications for participation in a program to identify new technologies at an upcoming trade show. For example, the organization PDA, of Bethesda, Md., USA, distributes applications for a New Innovation Technologies Exhibition (NITE™) Program. The applications may be distributed in any fashion known in the art. For example, the applications may be distributed as paper forms that are part of or separate from registration forms to attend or exhibit at the trade show. The paper forms may be published in a journal, or newspaper, or other publication, or may be distributed in a mass or directed mailing. In some embodiments, the application form is a document transferred over a public or private network, such as a word processing program file including a table or form attached to electronic mail (email) or available for download using any of a variety of file transfer protocols (e.g., FTP). In some embodiments, the application form is all or part of a web page available on the World Wide Web accessible over the Internet to receive user input at a client computer for transmission to a server computer. Such a page might have an HTML form or embedded applet or other Web browser plug-in written in a computer programming language such as JAVA™.

The application has one or more fields where an applicant can supply information used to evaluate the technology to be presented. For example, in an illustrated embodiment, the application is part of a registration form in which the applicant provides registration information such as the name and address and contact points for the registrant. In the illustrated embodiment, the application field included in the registration form is a text field labeled as shown in Table 1.

TABLE 1
NITE Program Application Form.

| Label | Text Field |
|---|---|
| New, Innovative Technologies Exhibition ™ | |
| (NITE ™) Program for the PDA Conference, | |
| Orlando, Florida, March 2004. Please | |
| provide a 100-word abstract of your new | |
| product/service for consideration by the | |
| NITE ™ Program. Describe specifically how | |
| and why it is first in its class. © PDA 2004 | |

The label is associated with a field where the applicant can enter the abstract.

In an illustrated embodiment, the application includes more descriptive information about the program. An incentive for a registrant to fill in the extra requested material is the prestige of being designated a new significant technology, e.g. a “NITE™ Program Awardee Exhibit” in the illustrated embodiment. In some embodiments exhibitors may pay extra to be considered for this prestigious designation. In some embodiments, additional incentives are added to entice participation in the program. For example, in an illustrated embodiment, the text depicted in Table 2 is included in the application.

TABLE 2
Application text offering additional enticements to apply for consideration
by the NITE ™ Program.

Descriptive Text:
Subject: New, Innovative Technologies (NITE ™) at PDA Conference!
Dear Exhibitor:
PDA is looking for new, innovative technologies to be launched at PDA
Conference in March. Does your company have new products or services
to showcase?
If so, please complete the attached form and send it back to PDA. Your
product or service abstract will be reviewed by a PDA peer-review
committee, and if it meets specific criteria you will be eligible to receive:
A discounted or free booth
Free advertising in the show directory
Free advertising in PDA Letter
Promotion on PDA’s Web site for six months after the show
A special announcement in opening plenary session at Conference
*Awards will be granted based on the assessment made by the
PDA peer-review committee.
If you have new products or services to display, we’d love to hear from
you. Please send all details to *****, email: ****@****.org
© PDA 2004

In the illustrated embodiment the incentives are:
1) highlighting for the particular exhibit in a program for the trade show;
2) reduced fee for exhibition space for the particular exhibit (including reduction to zero fee);
3) reduced fee for advertising in the program for the trade show (including reduction to zero fee);
4) reduced fee for advertising in a newsletter of an organization that administers the trade show (including reduction to zero fee); and
5) reduced fee for advertising on a web site hosted by the organization that administers the trade show (including reduction to zero fee).
   In other embodiments, any enticements may be used as the additional incentive, including any or all the incentives included in the illustrated embodiment, or other enticements not listed.

In step 120, the organization receives one or more completed applications. In some embodiments, the reception of a completed application is a multi- step process with one or more screening steps by the organization. FIG. 2 is a flow diagram that illustrates in more detail a multi-step embodiment 120* of step 120.

After step 110, in step 210, the organization receives a filled-in partial application. For example, the PDA organization receives an abstract filled in the text field described above, as shown in Table 3.

TABLE 3
Filled-in NITE ™ Program Application Form.

| Label | Text Field |
|---|---|
| New, Innovative Technologies Exhibition | Corp X has just introduced an image |
| (NITE ™) Program for the PDA Conference, | processor that automatically determines |
| Orlando, Florida, March 2004. Please | principal components of patterns of |
| provide a 100-word abstract of your new | fluorescent markers bounded to a molecular |
| product/service for consideration by the | fragment array. The processor can |
| NITE ™ Program. Describe specifically how | distinguish patterns that differ by as little as |
| and why it is first in its class. © PDA 2004 | one part in 10⁶. |

In step 220, the filled-in partial application is screened by organization staff. For example, staff of the organization read the abstracts and determine whether the product or service is already known to them from prior trade shows or experience. If so, the application is not considered further. If the product or service appears new to the staff, control passes to step 230. In an illustrated embodiment, the PDA staff that screen the partial applications are the President, Vice President Science & Technology, Vice President Education Director, Vice President Quality and Regulatory Affairs, Vice President Finance & Strategic Planning, and Senior Sales Manager. For purposes of illustration, it is assumed that the product described by Corp X appears new to the staff of PDA. In some embodiments step 220 is performed, at least in part, by a sampling of the membership. In some embodiments the input of the membership sampling is weighted based on the membership status of the expert, e.g., whether a full individual member, an associate member, an honorary member, an emeritus member, etc.

In step 230, a follow-up application is sent to the applicant to obtain additional information. The follow-up application is sent in any manner known in the art, as described above, such as paper forms in a directed mailing, and email, or an email with a link to a special web page with embedded form. For example, the applicant is requested to fill in a form as depicted in Table 4.

TABLE 4
Follow-up application form for the NITE ™ Program.

| Follow-up Information requested | Text field |
|---|---|
| A. What is the incremental benefit to current | |
| practices in the industiy? © PDA 2004 | |
| B. When was or will the first commercial | |
| sale of this product/service? © PDA 2004 | |
| C. What is the stage of your product | |
| development? © PDA 2004 | |
| D. Are you fully financed to complete | |
| commercialization? © PDA 2004 | |

In step 240, a filled-in follow-up application is received by the organization. For example, PDA receives the information depicted in Table 5.

TABLE 5
Filled-in Follow-up application form for the NITE ™ Program.

| Follow-up Information requested | Text field |
|---|---|
| A. What is the incremental benefit to current | Current automatic processors can detect |
| practices in the industry? © PDA 2004 | pattern changes only to the level of one part |
| | in 10⁴. The new processor satisfies Federal |
| | Government requirements for detecting |
| | differences in biological entities. |
| B. When was or will the first commercial | This processor will be available |
| sale of this product/service? © PDA 2004 | commercially in August 2004. |
| C. What is the stage of your product | Prototypes have been thoroughly tested. The |
| development? © PDA 2004 | software is going through final revisions. |
| D. Are you fully financed to complete | Yes. |
| commercialization? © PDA 2004 | |

In other embodiments more or fewer follow-up applications are requested and screened.

In step 250 a completed application is formed based on the initial and one or more filled-in follow-up applications. For example, a completed application for Corp X is formed by combining the information in Table 3 and Table 5. Control then passes to step 130, as described further with reference to FIG. 1.

In step 130, the completed applications are screened and edited by organization staff to form ballots for peer review. A benefit of this step is to streamline the review process to be performed by experts in subsequent steps, and therefore to conserve valuable expert person hours. Various criteria are applied in different embodiments to screen out applications that will not be considered further. For example, according to an example criterion applied in an illustrated embodiment, a product or service is considered not eligible for the NITE program if the first commercialization date is more than a year before the conference or more than a year after the conference, or if funding is not available to complete commercialization, or both. Such a product or service is screened out, and not passed to the next step for processing. In some embodiments step 130 is performed, at least in part, by a sampling of the membership. In some embodiments the input of the membership sampling is weighted based on the membership status of the expert, e.g., whether a full individual member, an associate member, an honorary member, an emeritus member, etc.

During step 130, information is edited out that is considered sensitive to the vendor, e.g., that the vendor would not want made public, and not necessary for the evaluation by the experts in subsequent steps. For example, after the date of first commercial sale is used to screen the application, that information is not relevant for evaluation by the experts, so it can be removed from the information passed to the experts. The information that remains for evaluation by the experts and the questions asked of the experts constitutes a ballot form that is passed to the experts. Table 6 shows the ballot for the illustrated embodiment.

TABLE 6
Ballot Form for the NITE ™ Program.

| Information requested | Text field |
|---|---|
| New, Innovative Technologies Exhibition ™ | Corp X has just introduced an image |
| (NITE) Program for the PDA Conference, | processor that automatically determines |
| Orlando, Florida, March 2004. Please | principal components of patterns of |
| provide a 100-word abstract of your new | fluorescent markers bounded to a molecular |
| product/service for consideration by the | fragment array. The processor can |
| NITE Program. Describe specifically how | distinguish patterns that differ by as little as |
| and why it is first in its class. © PDA 2004 | on part in 10⁶. |
| A. What is the incremental benefit to current | Current automatic processors can detect |
| practices in the industry? © PDA 2004 | pattern changes only to the level of one part |
| | in 10⁴. The new processor satisfies Federal |
| | Government requirements for detecting |
| | differences in biological entities. |
| Survey Question A. Is the product or service | |
| described commercially available today? | |
| (Y/N) © PDA 2004 | |
| Survey Question B. Is the product or service | |
| described unique or an improvement over | |
| what is available today? (Y/N) © PDA 2004 | |
| Survey Question C. Is the product or service | |
| described a potential significant | |
| improvement over what is available today in | |
| your interest group? (Y/N) © PDA 2004 | |
| What is your industry/interest group? | |
| © PDA 2004 | |

In step 140 the ballots are sent to experts. Any method may be used to send the forms, as described above, including paper forms directly mailed and emails with attached forms or links to special web pages. In some embodiments, step 140 includes determining one or more experts in each of one or more areas of technical expertise within the industry represented by the organization or trade show or both. In an illustrated embodiment, the experts are selected from interest groups already formed by employees of members of the organization whose services are donated to the organization by the members. There are several advantages of this arrangement. One advantage is that the organization already has interest groups formed as various sections of the organization to review submissions to publications, to test new devices, and to report on new products and service. Another advantage is that by virtue of serving on groups for the organization, the employees each have a duty to the organization and all its members that supercedes the employee's duty to the employee's employer. If the employee's duty to the organization conflicts with the employee's duty to the employer, the duty to the organization must prevail or the employee can recuse himself or herself from acting for the organization. This special duty to the organization ensures the desired objectivity by the expert when filling in the ballot.

For example step 140 includes sending the ballot listed in Table 6 to one or more experts in each of the interest groups of the PDA organization including interest groups in pharmacology, biopharmacology, medical devices and human life sciences.

In step 150, the organization receives the expert reviews. For example, PDA receives filled-in ballots from the member employees serving in the interest groups.

In step 160, the exhibits that qualify as new technologies are determined based on the ballots. Any method may be used to make this determination. In one embodiment, the results on the ballots are simply tabulated and any exhibit associated with more Yes votes than No votes for one or more areas of technical expertise is considered an awardee of the new technology program. In another embodiment, the Yes and No counts from different experts are given different weights. In some such embodiments, the weights are based on comments provided by the experts on the filled-in ballots. In some embodiments, the expert's area of expertise is used to weight the expert's vote. In some embodiments where the experts do not have a fiduciary duty to the membership, the weights are based on the degree of conflict for the expert, as perceived by the organization staff. In some embodiments the weights are based on the membership status of the expert, e.g., whether a full individual member, an associate member, an honorary member, an emeritus member, etc.

In step 180, the awardees of the new technology program are presented as new technologies at the trade show. For example, in an illustrated embodiment, the text listed in Table 7 is included in a directory for the trade show.

In step 190, any additional incentives offered to awardees are provided to the awardees selected in step 160. In the illustrated embodiment, in step 190, the six companies listed in Table 7 are each provided with a discounted or free booth, free advertising in the show directory, free advertising in PDA Letter, promotion on PDA's Web site for six months after the show, and a special announcement in opening plenary session at Conference.

TABLE 7
Conference Directory text for the PDA Conference.

Descriptive Text:
New Programs at PDA Conference
1. The New, Innovative Technologies Exhibition ™
(NITE ™) Program:
A New Science and Technology Program
The new PDA NITE ™ Program is designed to ensure that the PDA
membership is exposed to recently introduced and soon-to-be introduced
technologies that will help members and their companies stay ahead. The
program is designed to encourage companies to target PDA events for
their new technology market introductions by providing these companies
with special incentives.
When new, innovative technologies and services are first to market, PDA
members will be the first to know.
The PDA NITE ™ Program utilizes two PDA peer-review systems. Both
the NITE ™ Board and industry expert peer-review groups work to assure
products submitted for participation in the NITE ™ Program are new and
valuable to PDA members. “New” means released for sale within the
prior twelve months or projected to be released for sale within the
immediate future 12 months
PDA congratulates the following companies, whose new technologies
passed the PDA peer-review process to be displayed at the PDA NITE ™
Program at The PDA Conference in Orlando, Florida, March, 2004. Be
sure to stop by their specially marked booths to learn about these new
technologies!

| NITE Company | Conference Booth # |
|---|---|
| Corp X | 535 |
| The Y Company | 559 |
| Z, Inc. | 630 |
| The A Corporation | 628 |
| B Incorporated | 622 |
| C D & E CORP | 560 |
| © PDA 2004 | |

### Hardware Overview

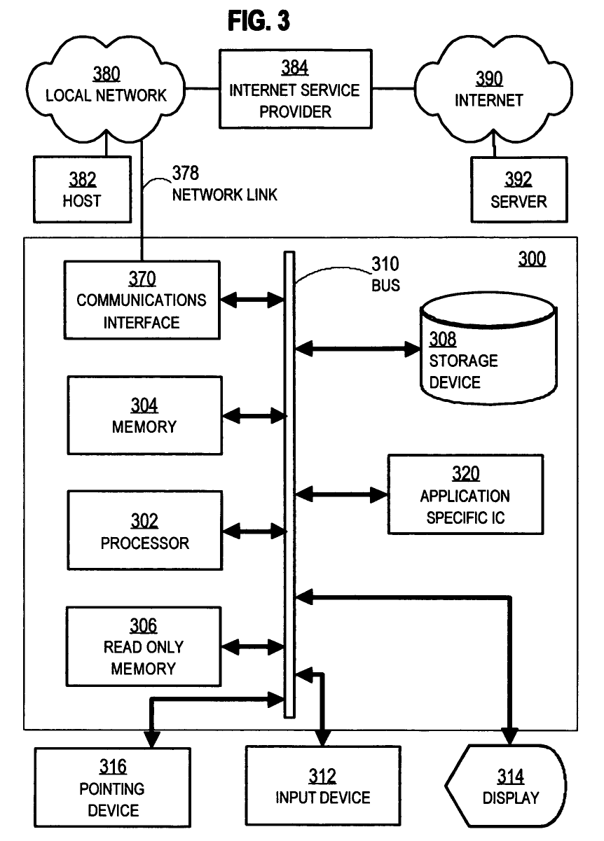

FIG. 3 is a block diagram that illustrates a computer system 300 upon which an embodiment of the invention may be implemented. Computer system 300 includes a communication mechanism such as a bus 310 for passing information between other internal and external components of the computer system 300. Information is represented as physical signals of a measurable phenomenon, typically electric voltages, but including, in other embodiments, such phenomena as magnetic, electromagnetic, pressure, chemical, molecular and atomic interactions. For example, north and south magnetic fields, or a zero and non-zero electric voltage, represent two states (0, 1) of a binary digit (bit). A sequence of binary digits constitutes digital data that is used to represent a number or code for a character. A bus 310 includes many parallel conductors of information so that information is transferred quickly among devices coupled to the bus 310. One or more processors 302 for processing information are coupled with the bus 310. A processor 302 performs a set of operations on information. The set of operations include bringing information in from the bus 310 and placing information on the bus 310. The set of operations also typically include comparing two or more units of information, shifting positions of units of information, and combining two or more units of information, such as by addition or multiplication. A sequence of operations to be executed by the processor 302 constitute computer instructions.

Computer system 300 also includes a memory 304 coupled to bus 310. The memory 304, such as a random access memory (RAM) or other dynamic storage device, stores information including computer instructions. Dynamic memory allows information stored therein to be changed by the computer system 300. RAM allows a unit of information stored at a location called a memory address to be stored and retrieved independently of information at neighboring addresses. The memory 304 is also used by the processor 302 to store temporary values during execution of computer instructions. The computer system 300 also includes a read only memory (ROM) 306 or other static storage device coupled to the bus 310 for storing static information, including instructions, that is not changed by the computer system 300. Also coupled to bus 310 is a non-volatile (persistent) storage device 308, such as a magnetic disk or optical disk, for storing information, including instructions, that persists even when the computer system 300 is turned off or otherwise loses power.

Information, including instructions, is provided to the bus 310 for use by the processor from an external input device 312, such as a keyboard containing alphanumeric keys operated by a human user, or a sensor. A sensor detects conditions in its vicinity and transforms those detections into signals compatible with the signals used to represent information in computer system 300. Other external devices coupled to bus 310, used primarily for interacting with humans, include a display device 314, such as a cathode ray tube (CRT) or a liquid crystal display (LCD), for presenting images, and a pointing device 316, such as a mouse or a trackball or cursor direction keys, for controlling a position of a small cursor image presented on the display 314 and issuing commands associated with graphical elements presented on the display 314.

In the illustrated embodiment, special purpose hardware, such as an application specific integrated circuit (IC) 320, is coupled to bus 310. The special purpose hardware is configured to perform operations not performed by processor 302 quickly enough for special purposes. Examples of application specific ICs include graphics accelerator cards for generating images for display 314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 300 also includes one or more instances of a communications interface 370 coupled to bus 310. Communication interface 370 provides a two-way communication coupling to a variety of external devices that operate with their own processors, such as printers, scanners and external disks. In general the coupling is with a network link 378 that is connected to a local network 380 to which a variety of external devices with their own processors are connected. For example, communication interface 370 may be a parallel port or a serial port or a universal serial bus (USB) port on a personal computer. In some embodiments, communications interface 370 is an integrated services digital network (ISDN) card or a digital subscriber line (DSL) card or a telephone modem that provides an information communication connection to a corresponding type of telephone line. In some embodiments, a communication interface 370 is a cable modem that converts signals on bus 310 into signals for a communication connection over a coaxial cable or into optical signals for a communication connection over a fiber optic cable. As another example, communications interface 370 may be a local area network (LAN) card to provide a data communication connection to a compatible LAN, such as Ethernet. Wireless links may also be implemented. For wireless links, the communications interface 370 sends and receives electrical, acoustic or electromagnetic signals, including infrared and optical signals, that carry information streams, such as digital data. Such signals are examples of carrier waves.

The term computer-readable medium is used herein to refer to any medium that participates in providing instructions to processor 302 for execution. Such a medium may take many forms, including, but not limited to, non-volatile media, volatile media and transmission media. Non-volatile media include, for example, optical or magnetic disks, such as storage device 308. Volatile media include, for example, dynamic memory 304. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 378 typically provides information communication through one or more networks to other devices that use or process the information. For example, network link 378 may provide a connection through local network 380 to a host computer 382 or to equipment 384 operated by an Internet Service Provider (ISP). ISP equipment 384 in turn provides data communication services through the public, world-wide packet-switching communication network of networks now commonly referred to as the Internet 390. A computer called a server 392 connected to the Internet provides a service in response to information received over the Internet. For example, server 392 provides information representing video data for presentation at display 314.

In some embodiments of the invention, computer system 300 is used for implementing at least some the steps described herein. According to one embodiment of the invention, those steps are performed by computer system 300 in response to processor 302 executing one or more sequences of one or more instructions contained in memory 304. Such instructions, also called software and program code, may be read into memory 304 from another computer-readable medium such as storage device 308. Execution of the sequences of instructions contained in memory 304 causes processor 302 to perform the method steps described herein. In alternative embodiments, hardware, such as application specific integrated circuit 320, may be used in place of or in combination with software to implement the invention. Thus, embodiments of the invention are not limited to any specific combination of hardware and software.

The signals transmitted over network link 378 and other networks through communications interface 370, which carry information to and from computer system 300, are exemplary forms of carrier waves. Computer system 300 can send and receive information, including program code, through the networks 380, 390 among others, through network link 378 and communications interface 370. In an example using the Internet 390, a server 392 transmits program code for a particular application, requested by a message sent from computer 300, through Internet 390, ISP equipment 384, local network 380 and communications interface 370. The received code may be executed by processor 302 as it is received, or may be stored in storage device 308 or other non-volatile storage for later execution, or both. In this manner, computer system 300 may obtain application program code in the form of a carrier wave.

Various forms of computer readable media may be involved in carrying one or more sequence of instructions or data or both to processor 302 for execution. For example, instructions and data may initially be carried on a magnetic disk of a remote computer such as host 382. The remote computer loads the instructions and data into its dynamic memory and sends the instructions and data over a telephone line using a modem. A modem local to the computer system 300 receives the instructions and data on a telephone line and uses an infra-red transmitter to convert the instructions and data to an infra-red signal, a carrier wave serving as the network link 378. An infrared detector serving as communications interface 370 receives the instructions and data carried in the infrared signal and places information representing the instructions and data onto bus 310. Bus 310 carries the information to memory 304 from which processor 302 retrieves and executes the instructions using some of the data sent with the instructions. The instructions and data received in memory 304 may optionally be stored on storage device 308, either before or after execution by the processor 302.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method for presenting new technology at a trade show, comprising the steps of:
sending, to a plurality of candidate exhibitors for a trade show in an industry, a plurality of applications to present an exhibit at the trade show as a new technology directed to the industry;
receiving from an exhibitor a completed application based on the plurality of applications;
determining a plurality of experts within the industry who are substantively independent of the exhibitor from whom the completed application is received;
obtaining a plurality of expert reviews from the plurality of experts based on at least a portion of the completed application; and
based on the plurality of expert reviews, presenting a particular exhibit at the trade show as a new technology.

2. The method as recited in claim 1, wherein the exhibit describes at least one of a product and a service offered by the exhibitor.

3. The method as recited in claim 1, said step of sending the plurality of applications further comprising sending first instructions for the exhibitor to provide in a completed application first data that describes a new technology in an exhibit with a limited number of words.

4. The method as recited in claim 1, said step of sending the plurality of applications further comprising sending second instructions for the exhibitor to provide in a completed application second data that describes an incremental benefit to current practices in the industry.

5. The method as recited in claim 1, said step of sending the plurality of applications further comprising sending third instructions for the exhibitor to provide in a completed application third data that describes a stage of development associated with the exhibit.

6. The method as recited in claim 1, said step of sending the plurality of applications further comprising sending fourth instructions for the exhibitor to provide in a completed application fourth data that describes a date of first availability applicable to the exhibit.

7. The method as recited in claim 1, further comprising:
determining a subset of zero or more completed applications based on the one or more completed applications and a criterion for new technology; and
sending to the plurality of experts only the subset of completed applications.

8. The method as recited in claim 7, said step of determining the subset further comprising determining the subset based on a date of first availability applicable to an exhibit associated with a completed application.

9. The method as recited in claim 8, said step of determining the subset further comprising determining the subset based on a difference between the date of first availability and a date of the trade show.

10. The method as recited in claim 7, said step of determining the subset of the completed applications based on a criterion for new technology is performed by staff of an organization that administers the trade show.

11. The method as recited in claim 1, further comprising:
determining, for each completed application, a first portion that contains less than all information in each completed application; and
sending to the plurality of experts only the first portion each completed application.

12. The method as recited in claim 11, said step of determining the first portion further comprising determining a portion that an exhibitor associated with a completed application is not adverse to making public.

13. The method as recited in claim 1, said step of receiving the completed application further comprising:
receiving one or more partially completed applications from an initial exhibitor based on the plurality of applications;
determining a subset of one or more partially completed applications based on a criterion for new technology;
sending a follow-up application to a select exhibitor associated with the subset of one or more partially completed applications;
receiving a completed follow-up application from the exhibitor; and
forming the completed application based on the initial partially completed application and the completed follow-up application.

14. The method as recited in claim 13, said step of determining the subset of one or more partially completed applications based on a criterion for new technology is performed by staff of an organization that administers the trade show.

15. The method as recited in claim 1, said step of determining the plurality of experts further comprising selecting the plurality of experts from employees of members of an organization that administers the trade show, wherein the employee of one member of the organization owes a fiduciary duty to other members of the organization while preparing the expert review.

16. The method as recited in claim 1, said step of determining the plurality of experts further comprising selecting an expert in each of a plurality of areas of technical expertise within the industry.

17. The method as recited in claim 1, wherein:
said step of sending the plurality of applications further comprises including in the plurality of applications an offer of an extra incentive for an exhibitor associated with an exhibit presented at the trade show as a new technology; and
the method further comprises providing the extra incentive to a particular exhibitor associated with the particular exhibit.

18. The method as recited in claim 17, said extra incentive including at least one of:
highlighting for the particular exhibit in a program for the trade show;
reduced fee for exhibition space for the particular exhibit;
reduced fee for advertising in the program for the trade show;
reduced fee for advertising in a newsletter of an organization that administers the trade show; and
reduced fee for advertising on a web site hosted by the organization that administers the trade show.

19. The method as recited in claim 1, said step of receiving a completed application from an exhibitor further comprising receiving an extra fee from the exhibitor associated with the completed application.

20. A computer-readable medium carrying one or more sequences of instructions for presenting new technology at a trade show, wherein execution of the one or more sequences of instructions by one or more processors causes the one or more processors to perform the steps of:
sending, to a plurality of candidate exhibitors for a trade show in an industry, a plurality of applications to present an exhibit at the trade show as a new technology directed to the industry;
receiving from an exhibitor one or more completed applications based on the plurality of applications;
determining a plurality of experts within the industry who are substantively independent of the exhibitor from whom the completed application is received;
sending at least a subset of the one or more completed applications to the plurality of experts;
receiving a plurality of expert reviews from the plurality of experts based on at least the subset of the one or more completed applications; and
based on the plurality of expert reviews, determining a particular exhibit to present at the trade show as a new technology.
